(19) United States
(12) Patent Application Publication
(10) Pub. No.: US 2019/0219874 A1
(43) Pub. Date: Jul. 18, 2019

(54) BACKLIGHT MODULE AND DISPLAY DEVICE

(71) Applicant: HUIZHOU CHINA STAR OPTOELECTRONICS TECHNOLOGY CO., LTD., Huizhou Guangdong (CN)

(72) Inventors: Jianyu CHANG, Shenzhen (CN); Yung-Jui LEE, Shenzhen (CN); Yuchun HSIAO, Shenzhen (CN); Sheng-jer CHANG CHIEN, Shenzhen (CN)

(21) Appl. No.: 16/023,787

(22) Filed: Jun. 29, 2018

Related U.S. Application Data
(63) Continuation of application No. PCT/CN2018/074298, filed on Jan. 26, 2018.

(30) Foreign Application Priority Data
Jan. 16, 2018 (CN) 201810044152.X

(51) Int. Cl. G02F 1/1335

(52) U.S. Cl. CPC G02F 1/133609; G02F 2001/133614; G02F 1/133606; G02F 1/133603

(57) ABSTRACT

The invention provides a backlight module, comprising a backlight source, a light-guiding plate, and a quantum dot layer, all stacked in sequence; the quantum dot layer comprising: a first surface and a second surface, oppositely disposed, the second surface being adhered to the light-guiding plate, and the quantum dot layer being disposed with a plurality of first areas and a plurality of second areas formed between the first surface and the second surface; each first area being disposed between two adjacent second areas so as to form the first area and the second area alternately arranged; the first area having a concentration of the quantum dots less than concentration of the quantum dots in the second area; the first surface forming the first areas comprising a first curved surface, and the first curved surface being used to perform scattering on light passing through the first area.

### CROSS REFERENCE TO RELATED APPLICATIONS

This application is a continuing application of PCT Patent Application No. PCT/CN2018/074298, entitled “BACKLIGHT MODULE AND DISPLAY DEVICE”, filed on Jan. 26, 2018, which claims priority to Chinese Patent Application No. CN201810044152.X, filed on Jan. 16, 2018, both of which are hereby incorporated in its entireties by reference.

### BACKGROUND OF THE INVENTION

### 1. Field of the Invention

The present invention relates to the field of display and, in particular, to the field of backlight module and display device.

### 2. The Related Arts

The backlight module provides light for the display device and is an important component of the display device. The backlight module mainly comprises a light-emitting diode (LED), a light-guiding plate, a quantum dot film, and a prism film, wherein the LED is located at one side of the light-guiding plate, and the quantum dot film is disposed between the light-guiding plate and the prism film. The light emitted from the LED changes the emitting direction by the light-guiding plate and then passes the quantum dot film and the prism film to emit. The quantum dot film is for providing quantum dots, which can emit light when excited by the light emitted from the LED. The light emitted by the quantum dots and the light emitted by the LED are mixed to form white light to enhance the display effect of the display device.

The quantum dots in the quantum dot film ahs a scattering effect on the light. However, when the concentration distribution of the quantum dots is uneven, the area with low concentration of quantum dots in the quantum dot film absorbs less light and results in the light emitted from the low concentration area has a smaller range of emission, which affects the backlight module efficiency and the display effect of the display device, as well as color shift issue at large viewing angle.

### SUMMARY OF THE INVENTION

The primary object of the present invention is to provide a backlight module and display device, able to improve the color shift problem at large viewing angle.

To solve the above technical issue, the present invention provides a backlight module, which comprises: a backlight source, a light-guiding plate, and a quantum dot layer, all stacked in sequence; the quantum dot layer comprising: a first surface and a second surface, oppositely disposed, the second surface being adhered to the light-guiding plate, and the quantum dot layer being disposed with a plurality of first areas and a plurality of second areas formed between the first surface and the second surface; each first area being disposed between two adjacent second areas so as to form the first area and the second area alternately arranged; the first area having a concentration of the quantum dots less than concentration of the quantum dots in the second area; the first surface forming the first areas comprising a first curved surface, and the first curved surface being used to perform scattering on light passing through the first area.

According to a preferred embodiment of the present invention, the first surface forming the second areas comprises a first flat surface, and the first flat surface is connected between adjacent first curved surfaces.

According to a preferred embodiment of the present invention, the first curved surface comprises a first convex curved surface, and the first convex curved surface protrudes facing a direction away from the second surface.

According to a preferred embodiment of the present invention, the first curved surface further comprises a first concave curved surface, connected to the first convex curved surface, the first concave curved surface protrudes facing a direction towards the second surface.

According to a preferred embodiment of the present invention, the number of the first curved surfaces is a plurality, and the plurality of first curved surfaces are disposed with intervals or connectedly.

According to a preferred embodiment of the present invention, the second surface forming the second areas comprises a second curved surface, the second curved surface is for scattering light entering the second areas.

According to a preferred embodiment of the present invention, the second curved surface comprises a second convex curved surface and a concave curved surface, the second convex curved surface protrudes facing a direction towards the first surface, and the second concave curved surface protrudes facing a direction towards the first surface.

According to a preferred embodiment of the present invention, the second surface is a plurality of connected third curved surfaces, the third curved surface is for scattering light entering the quantum dot layer.

According to a preferred embodiment of the present invention, the light-guiding plate comprises a contact surface adhered to the second surface, the contact surface is disposed with a groove and a protrusion, the groove has an inner wall adhered to the second convex curved surface and the protrusion has an inner wall adhered to the second concave curved surface.

The present invention also provides a display device, and the display device comprises the above backlight module.

In the backlight module and the display device provided by the present invention, a quantum dot layer is disposed on a light-guiding plate of the backlight module, and areas with a lower quantum dot concentration and areas with a higher quantum dot concentration are alternately arranged between the first surface and the second surface of the quantum dot layer. A curved surface is formed on the first surface of the areas with a lower quantum dot concentration.. When the light emitted from the backlight source of the backlight module passes through the light-guiding plate and enters the quantum dot layer, because the areas with lower quantum dot concentration absorb less light, the exit angle of the light emitted from the areas with lower quantum dot concentration is also more concentrated. Therefore, the curved surface can perform scattering on the light passing through the area with lower quantum dot concentration, so that the range of exit angle of the light emitted from the areas with lower quantum dot concentration increases, thereby increasing the viewing angle of the display device.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a schematic view showing the structure of a display device according to an exemplary embodiment of the present invention.

FIG. 2 is a schematic view showing the structure of a backlight module according to the first exemplary embodiment of the present invention.

FIG. 3 is a schematic view showing the structure of a backlight module according to the second exemplary embodiment of the present invention.

FIG. 4 is a schematic view showing the structure of a backlight module according to the third exemplary embodiment of the present invention.

FIG. 5 is a schematic view showing the structure of a backlight module according to the fourth exemplary embodiment of the present invention.

FIG. 6 is a schematic view showing the structure of a backlight module according to the fifth exemplary embodiment of the present invention.

FIG. 7 is a schematic view showing the structure of a backlight module according to the sixth exemplary embodiment of the present invention.

FIG. 8 is a schematic view showing the structure of a backlight module according to the seventh exemplary embodiment of the present invention.

FIG. 9 is a schematic view showing the structure of a backlight module according to the eighth exemplary embodiment of the present invention.

### DETAILED DESCRIPTION OF THE PREFERRED EMBODIMENTS

To further explain the technical means and effect of the present invention, the following refers to embodiments and drawings for detailed description. Apparently, the described embodiments are merely some embodiments of the present invention, instead of all embodiments. All other embodiments based on embodiments in the present invention and obtained by those skilled in the art without departing from the creative work of the present invention are within the scope of the present invention.

The terms “comprising” and “having” and any variations thereof appearing in the specification, claims, and drawings of the present application are intended to cover non-exclusive inclusion. For example, a process, method, system, product, or device that includes a series of steps or units is not limited to the listed steps or units, but optionally also includes steps or units not listed, or alternatively, other steps or units inherent to these processes, methods, products or equipment. In addition, the terms “first”, “second” and “third” are used to distinguish different objects and not intended to describe a particular order.

In addition, the following description of various embodiments is provided with reference to additional drawings to exemplify specific embodiments that the invention may be used to implement. Directional terms mentioned in this specification, for example, “top”, “bottom”, “upper”, “lower”, “front”, “back”, “left”, “right”, “inside”, “outside”, and “side”, and the like, are only for reference to the direction of the appended drawings. Therefore, the directional terms are used to better and more clearly illustrate and understand the present invention, and do not indicate or imply that the indicated device or element must have the particular orientation, construction and operation in a particular orientation, and is not to be construed as limiting the present invention.

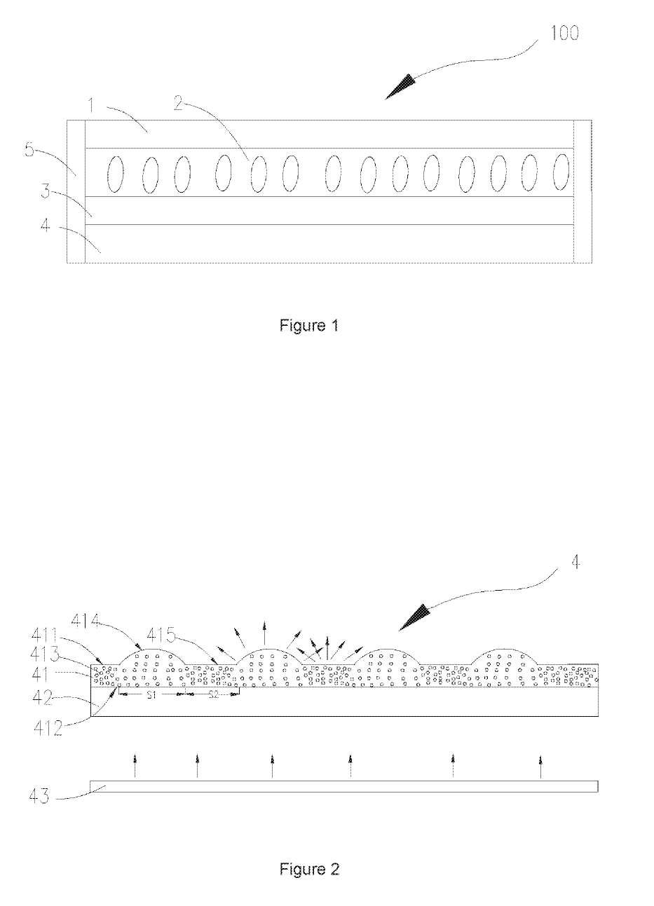

As shown in FIG. 1, FIG. 1 shows a display device 100 according to an exemplary embodiment of the present invention. The display device 100 comprises a color filter substrate 1, a liquid crystal layer 2, a thin film transistor (TFT) substrate 3, and a backlight module 4. The liquid crystal layer 2 is disposed between the color filter substrate 1 and the TFT substrate 3. The backlight module 4 is disposed to the side close to the TFT substrate 3 to provide light source for the display device 100. The color filter substrate 1, the TFT substrate 3, the liquid crystal layer 2 and the backlight module 4 are fixed together by a frame 5.

Refer to FIG. 2. FIG. 2 shows the backlight module 4 of the display device 100 in FIG. 1. The backlight module 4 is applied to the display device 100. The backlight module comprises: a quantum dot layer 41, a light-guiding plate 42, and a backlight source 43. The backlight source 43 is for emitting blue light, for example, the backlight source 43 can be a plurality of light-emitting diodes (LED) emitting blue light. The quantum dot layer 41 comprises quantum dot material. The quantum dot material absorbs the blue light emitted by the backlight source 43 and then transforms the blue light into red light and green light to form red, green, and blue light to emit from the backlight module 4.

In the present embodiment, as shown in FIG. 2, the quantum dot layer 41 is a quantum dot film. The quantum dot layer 41 comprises: a first surface 411 and a second surface 412, oppositely disposed. The second surface 412 is adhered to the light-guiding plate 42. The first surface 411 faces away from the light-guiding plate 42. The backlight source 43 is disposed at a side of the light-guiding plate 42 facing away from the quantum dot layer 41. In the propagation path of the light emitted from the backlight source 43, the light emitted from the backlight source 43 passes through the incident surface of the light-guiding plate 42 to enter the light-guiding plate 42, then passes through the light-exiting surface of the light-guiding plate 42 to exit the light-guiding plate 42, then passes through the second surface 412 of the quantum dot layer 41 to enter the quantum dot layer 41, reacts with the quantum dot material, forms red, green, and blue light, and finally passes through the first surface 411 to exit the quantum dot layer 41.

Refer to FIG. 2. The quantum dot layer 41 is disposed with a plurality of first areas S1 and a plurality of second areas S2 formed between the first surface 411 and the second surface 412. Each first area S1 is disposed between two adjacent second areas S2 so that the first area S1 and the second area S2 are alternately arranged. The first area S1 has a concentration of the quantum dots 413 less than concentration of the quantum dots 413 in the second area S2. The first surface 411 forming the first areas S1 comprises a first curved surface 414. That is, the first curved surface 414 is located on the first surface 411 at a position corresponding to the first area S1. When the light emitted from the backlight source 43 passes the light-guiding plate 42 and the quantum dot layer 41, the first curved surface 414 is used to scatter the light passing through the first area S1.

Because the areas with lower concentration of quantum dots 413 absorb less blue light, the exiting angle of the blue light emitted from the areas with lower concentration of quantum dots 413 is more concentrated, which may cause the color shift problem at large viewing angle. The embodiment of the present invention disposes the first curved surface 4141 on the side of the quantum dot layer 41 away from the light-guiding plate 42 and makes the first curved surface 414 face the areas with lower concentration of quantum dots 413, i.e., the first areas S1. When the light emitted from the backlight source 43 of the backlight module passes through the light-guiding plate 42 to enter the quantum dot layer 41, the first curved surface 414 can perform scattering on the light passing through the first areas S1 so that the range of the exiting angle for the light emitted from the first areas S1 is expanded so that the viewing angle of the display device 100 is increased and the color shift problem at large viewing angle for the display device 100 is solved.

In the first embodiment, as shown in FIG. 2, the first curved surface 414 is a first convex curved surface, the first convex curved surface is a protruding curved surface facing away from the second surface 412. When the light emitted from the first areas S1 passes through the first convex curved surface, the light is scattered, which increases the range of the exiting angle for the light emitted from the first areas S1 and increase the viewing angle of the display device.

In other embodiments, the first curved surface 414 is a protruding curved surface facing towards the second surface 412. With same principle as the protruding curved surface facing away from the second surface 412, the first curved surface 414 can also scatter the light emitted from the first areas S1 passes through the first convex curved surface, which increases the range of the exiting angle for the light emitted from the first areas S1 and increase the viewing angle of the display device.

Moreover, refer to FIG. 2. The first surface 411 forming the second areas S2 comprises a first flat surface 415, and the first flat surface 415 is connected between adjacent first curved surfaces 414. The first flat surface 415 is located on the first surface 411 at a location facing the second areas S2. Because the second areas S2 has a higher concentration of quantum dots 413, the blue light passing the second areas S2 is mostly absorbed. After absorbing the blue light, the quantum dots 413 emits the red and green light, which have a wider range of exiting angle; thus, the red and green light emitted from the first flat surface 415 have a wider range of exiting angle. With respect to the disposition of the curved surface, the disposition of the first flat surface 415 can reduce the cost of manufacturing the quantum dot layer 41 and is suitable for industrial mass production. In addition, the disposition of the first flat surface 415 can increase the adherence stability between the first surface 411 and other optical film layers.

In addition, the number of the first curved surface 414 can be a plurality and the plurality of first curved surfaces 414 are disposed with intervals. The number of the first flat surface 415 can be a plurality and the plurality of first flat surfaces 415 are disposed among the plurality of first curved surfaces 414.

The present invention does not set restriction on the number and the distribution of first curved surfaces 414 and first flat surfaces 415. The number and locations of the first curved surfaces 414 and first flat surfaces 415 can be adjusted according to the concentration distribution of the quantum dots 413 in the quantum dot layer 41.

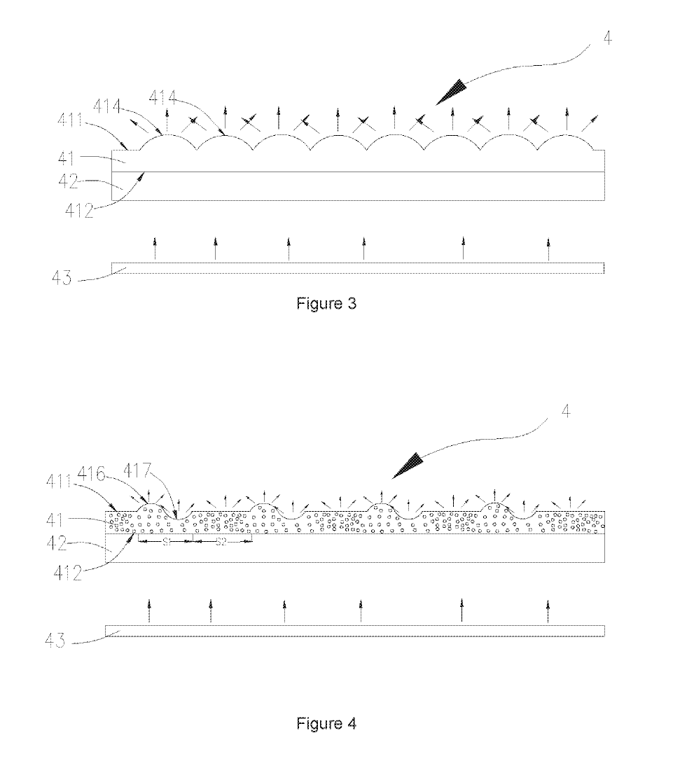

In the second embodiment, as shown in FIG. 3, the number of the first curved surfaces 414 is a plurality, and the plurality of first curved surfaces 414 are disposed connectedly. The connectedly disposed plurality of first curved surfaces 414 make the first surface 411 an uneven surface. The blue light emitted from the backlight source 43 propagates inside the light-guiding plate 42 and emits to the quantum dot layer 41. The quantum dots 413 in the quantum dot layer 41 absorb a portion of blue light and transform into red and green light. The exiting angle of the light emitted by the quantum dots 413 after absorbing blue light is random, and the exiting angle of the un absorbed blue light is basically unchanged, therefore, the first surface 411 of the quantum dot layer 41 being an uneven curved surface will change the exiting angle of the blue light to achieve scattering. As such, the exiting angle of the light from the quantum dot layer 41 comprises various possible angles and the white light formed by the red, green and blue light also comprises various angles; thus, the viewing angle of the display device 100 is effectively increased.

In the third embodiment, as shown in FIG. 4, the first curved surface 414 is a first convex curved surface 416 connected to a first concave curved surface 417. The first convex curved 416 protrudes away from the second surface 412, and the first concave curved 417 protrude towards the second surface 412. Both the first convex curved 416 and the first concave curved 417 scatter the exiting angle of the blue light from the first areas S1; thus, the viewing angle of the display device 100 is effectively increased.

In another embodiment, also refer to FIG. 4, the number of the first curved surface 414 is a plurality, the plurality of the first curved surfaces 414 are disposed with intervals, and the remaining places among the plurality of first curved surfaces 414 are flat.

In the fourth embodiment, as shown in FIG. 5, this embodiment differs from the third embodiment in that the number of the first curved surfaces 414 is a plurality, and the plurality of the first curved surfaces are disposed continuously, That is, the first surface 411 is disposed as an uneven wavy curved surface. The wavy curved surface can change the exiting angle of the blue light to achieve scattering. As such, the exiting angle of the light from the quantum dot layer 41 comprises various possible angles; thus, the viewing angle of the display device 100 is effectively increased.

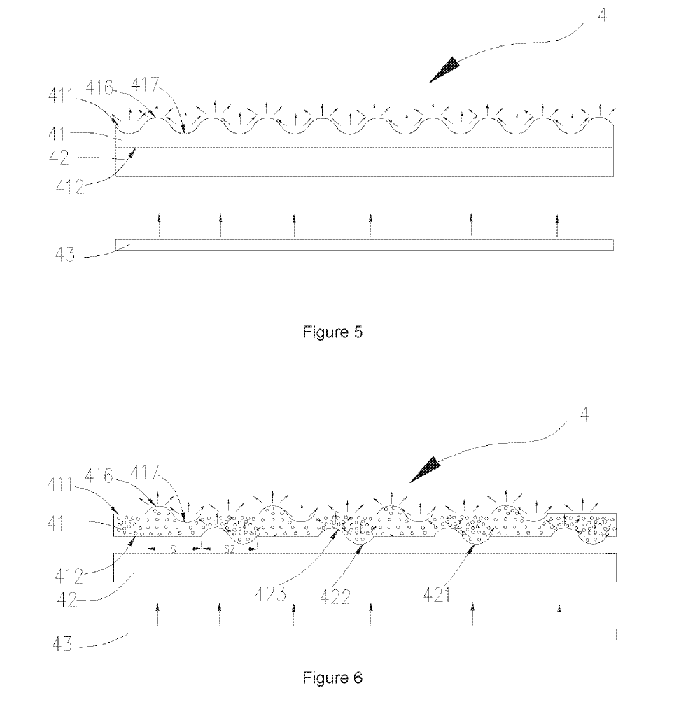

In the fifth embodiment, as shown in FIG. 6, the first curved surface 414 is a first convex curved surface 416 connected to a first concave curved surface 417. The first convex curved 416 protrudes away from the second surface 412, and the first concave curved 417 protrude towards the second surface 412. The number of the first curved surface 414 is a plurality, the plurality of the first curved surfaces 414 are disposed with intervals, and the remaining places among the plurality of first curved surfaces 414 are flat. The second surface S2 forming the second area S2 comprises a second curved surface 421. The incident surface of the first area S1 of the quantum dot layer 41 is disposed as a flat surface and the light-exiting surface of the first area S1 of the quantum dot layer 41 is disposed as a curved surface to guarantee more blue light entering the first area S1 as well as increase the exiting angle of the blue light to achieve effectively increasing the viewing angle of the display device 100. The incident surface of the second area S2 of the quantum dot layer 41 is disposed as a curved surface and the light-exiting surface of the second area S2 of the quantum dot layer 41 is disposed as a flat surface to guarantee increasing the exiting angle of the blue light entering the second area S2 to achieve effectively increasing the viewing angle of the display device 100.

In the present embodiment, the second curved surface 421 comprises a second convex curved surface 422 and a second concave curved surface 423; the second convex curved 422 protrudes away from the first surface 411, and the second concave curved 423 protrude towards the first surface 411.

In other embodiments, the second curved surface 421 can be a second convex curved surface 422 or a second concave curved surface 423.

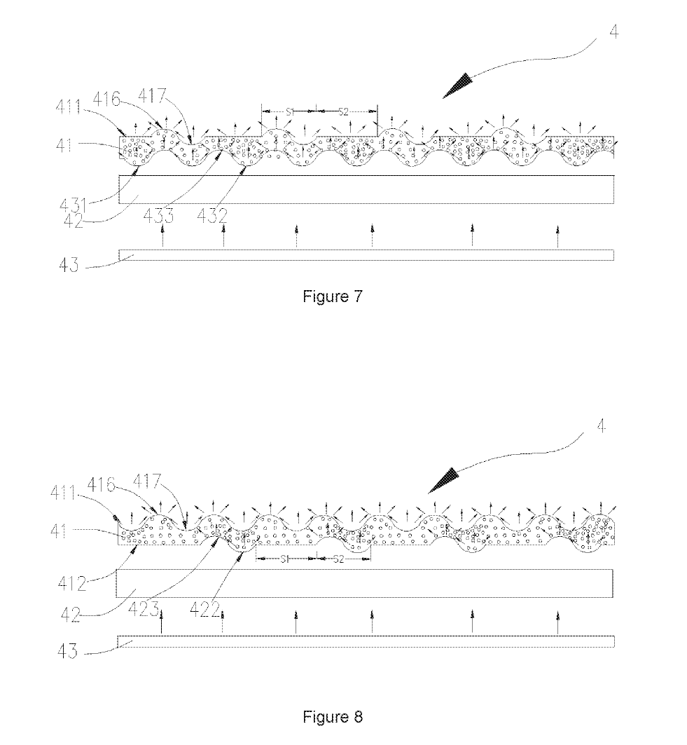

In the sixth embodiment, as shown in FIG. 7, the first curved surface 414 is a first convex curved surface 416 connected to a first concave curved surface 417. The first convex curved 416 protrudes away from the second surface 412, and the first concave curved 417 protrude towards the second surface 412. The number of the first curved surface 414 is a plurality, the plurality of the first curved surfaces 414 are disposed with intervals, and the remaining places among the plurality of first curved surfaces 414 are flat. The second surface 412 comprises a plurality of connected third curved surfaces 431, for scattering the light entering the quantum dot layer 41. The third curved surface 431 comprises a third convex curved surface 432 and a third concave curved surface 433; the third convex curved 432 protrudes away from the first surface 411, and the third concave curved 433 protrude towards the first surface 411.

In the present embodiment, the plurality of first curved surfaces 414 disposed with intervals face the first areas S1. In other embodiments, the plurality of first curved surfaces 414 can be disposed connectedly.

The first surface 411 and the second surface 412 of the quantum dot layer 41 are both disposed with curved surfaces, wherein the second surface 412 is a wavy curved surface to guarantee the blue light is scattered upon entering the quantum dot layer 41 to emit more evenly towards the quantum dots 413 in the quantum dot layer 41 to improve utilization efficiency of the blue light. After the two times of scattering in the quantum dot layer 41, the blue light is more even and the achieve better expansion effect. As such, the light emitted from the quantum dot layer 41 comprises various angles, and the synthetic white light also comprises various angles to effectively achieve increasing viewing angle of the display device 100.

In the seventh embodiment, as shown in FIG. 8, the first curved surface 414 is a first convex curved surface 416 connected to a first concave curved surface 417. The first convex curved 416 protrudes away from the second surface 412, and the first concave curved 417 protrude towards the second surface 412. The number of the first curved surface 414 is a plurality, the plurality of the first curved surfaces 414 are disposed connectedly. The second surface 412 comprises a second curved surface 421, and the second curved surface 412 is aligned with the second area S2. The second curved surface 421 comprises a second convex curved surface 422 and a second concave curved surface 423; the second convex curved 422 protrudes away from the first surface 411, and the second concave curved 423 protrude towards the first surface 411. The number of the second curved surfaces 421 can be a plurality, and the plurality of the second curved surfaces are disposed with intervals, and the locations among the first plurality of first curved surfaces are flat.

The first surface 411 and the second surface 412 of the quantum dot layer 41 are both disposed with curved surfaces, wherein the first surface 411 is a wavy curved surface to guarantee the blue light is scattered upon exiting the quantum dot layer 41 to increase the exiting angle. Wherein the second curved surface 412 is aligned with the second area S2. After the two times of scattering in the quantum dot layer 41, the blue light is more even and the achieve better expansion effect. As such, the light emitted from the quantum dot layer 41 comprises various angles, and the synthetic white light also comprises various angles to effectively achieve increasing viewing angle of the display device 100.

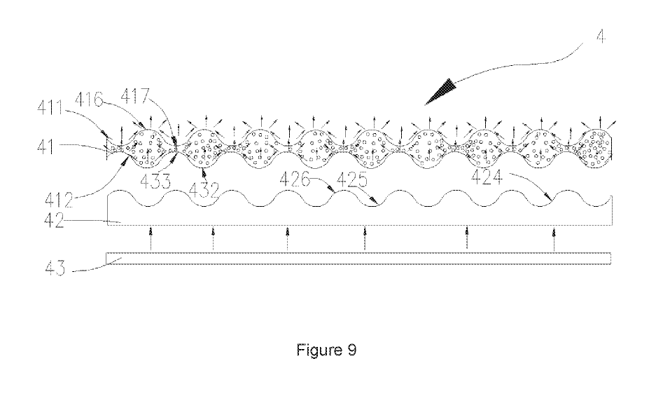

In the eighth embodiment, as shown in FIG. 9, this embodiment differs from the seventh embodiment in that the second surface 412 comprises a plurality of connected third curved surfaces 431, for scattering the light entering the quantum dot layer 41. The third curved surface 431 comprises a third convex curved surface 432 and a third concave curved surface 433; the third convex curved 432 protrudes away from the first surface 411, and the third concave curved 433 protrude towards the first surface 411.

The first surface 411 and the second surface 412 of the quantum dot layer 41 are both disposed with curved surfaces to guarantee the blue light is scattered upon entering the quantum dot layer 41 to emit more evenly towards the quantum dots 413 in the quantum dot layer 41 to improve utilization efficiency of the blue light. After the two times of scattering in the quantum dot layer 41, the blue light is more even and the achieve better expansion effect. As such, the light emitted from the quantum dot layer 41 comprises various angles, and the synthetic white light also comprises various angles to effectively achieve increasing viewing angle of the display device 100.

In another embodiment, also refer to FIG. 9, the light-guiding plate 42 comprises a contact surface 424 adhered to the second surface 412, the contact surface 424 is disposed with a groove 425 and a protrusion 426, the groove 425 has an inner wall adhered to the second convex curved surface 422 and the protrusion 426has an inner wall adhered to the second concave curved surface 423. In other embodiments, the contact surface 424 can also be flat.

It should be noted that each of the embodiments in this specification is described in a progressive manner, each of which is primarily described in connection with other embodiments with emphasis on the difference parts, and the same or similar parts may be seen from each other. For the device embodiment, since it is substantially similar to the method embodiment, the description is relatively simple and the relevant description may be described in part of the method embodiment.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A backlight module, comprising: a backlight source, a light-guiding plate, and a quantum dot layer, all stacked in sequence; the quantum dot layer comprising: a first surface and a second surface, oppositely disposed, the second surface being adhered to the light-guiding plate, and the quantum dot layer being disposed with a plurality of first areas and a plurality of second areas formed between the first surface and the second surface; each first area being disposed between two adjacent second areas so as to form the first area and the second area alternately arranged; the first area having a concentration of the quantum dots are less than concentration of the quantum dots in the second area; the first surface forming the first areas comprising a first curved surface, and the first curved surface being used to perform scattering on light passing through the first area.

2. The backlight module as claimed in claim 1, wherein the first surface forming the second areas comprises a first flat surface, and the first flat surface is connected between adjacent first curved surfaces.

3. The backlight module as claimed in claim 2, wherein the first curved surface comprises a first convex curved surface, and the first convex curved surface protrudes facing a direction away from the second surface.

4. The backlight module as claimed in claim 3, wherein the first curved surface further comprises a first concave curved surface, connected to the first convex curved surface, the first concave curved surface protrudes facing a direction towards the second surface.

5. The backlight module as claimed in claim 1, wherein the number of the first curved surfaces is plural a plurality, and the plurality of first curved surfaces are disposed spaced apart from each other or connectedly.

6. The backlight module as claimed in claim 1, wherein the second surface forming the second areas comprises a second curved surface, the second curved surface is used for scattering light entering the second areas.

7. The backlight module as claimed in claim 6, wherein the second curved surface comprises a second convex curved surface and a concave curved surface, the second convex curved surface protrudes facing a direction towards the first surface, and the second concave curved surface protrudes facing a direction towards the first surface.

8. The backlight module as claimed in claim 1, wherein the second surface is a plurality of connected third curved surfaces, the third curved surface is for scattering light entering the quantum dot layer.

9. The backlight module as claimed in claim 7, wherein the light-guiding plate comprises a contact surface adhered to the second surface, the contact surface is disposed with a groove and a protrusion, the groove has an inner wall adhered to the second convex curved surface and the protrusion has an inner wall adhered to the second concave curved surface.

10. A display device, comprising a backlight module, the backlight module comprising: a backlight source, a light-guiding plate, and a quantum dot layer, all stacked in sequence; the quantum dot layer comprising: a first surface and a second surface, oppositely disposed, the second surface being adhered to the light-guiding plate, and the quantum dot layer being disposed with a plurality of first areas and a plurality of second areas formed between the first surface and the second surface; each first area being disposed between two adjacent second areas so as to form the first area and the second area alternately arranged; the first area having a concentration of the quantum dots are less than concentration of the quantum dots in the second area; the first surface forming the first areas comprising a first curved surface, and the first curved surface being used to perform scattering on light passing through the first area.

11. The display device as claimed in claim 10, wherein the first surface forming the second areas comprises a first flat surface, and the first flat surface is connected between adjacent first curved surfaces.

12. The display device as claimed in claim 11, wherein the first curved surface comprises a first convex curved surface, and the first convex curved surface protrudes facing a direction away from the second surface.

13. The display device as claimed in claim 12, wherein the first curved surface further comprises a first concave curved surface, connected to the first convex curved surface, the first concave curved surface protrudes facing a direction towards the second surface.

14. The display device as claimed in claim 10, wherein the number of the first curved surfaces is plural, and the plurality of first curved surfaces are disposed spaced apart from each other or connectedly.

15. The display device as claimed in claim 10, wherein the second surface forming the second areas comprises a second curved surface, the second curved surface is used for scattering light entering the second areas.

16. The display device as claimed in claim 15, wherein the second curved surface comprises a second convex curved surface and a concave curved surface, the second convex curved surface protrudes facing a direction towards the first surface, and the second concave curved surface protrudes facing a direction towards the first surface.

17. The display device as claimed in claim 10, wherein the second surface is a plurality of connected third curved surfaces, the third curved surface is for scattering light entering the quantum dot layer.

18. The display device as claimed in claim 16, wherein the light-guiding plate comprises a contact surface adhered to the second surface, the contact surface is disposed with a groove and a protrusion, the groove has an inner wall adhered to the second convex curved surface and the protrusion has an inner wall adhered to the second concave curved surface.
